(19) United States
(12) Patent Application Publication
(10) Pub. No.: US 2020/0316762 A1
(43) Pub. Date: Oct. 8, 2020

(54) MODIFIED CAP NAIL SECURING SYSTEM

(71) Applicants: James Laplaunte, Dain City (CA); Elliott LeBlanc, Dain City (CA); Victor Valdivia, Dain City (CA); Marcelo Pena, Dain City (CA)

(72) Inventors: James Laplaunte, Dain City (CA); Elliott LeBlanc, Dain City (CA); Victor Valdivia, Dain City (CA); Marcelo Pena, Dain City (CA)

(21) Appl. No.: 16/375,563

(22) Filed: Apr. 4, 2019

(51) Int. Cl. B25C 1/00; B25C 5/10

(52) U.S. Cl. CPC B25C 1/001; B25C 5/10

(57) ABSTRACT

A nail cap gun is modified whereby a gun that produces a two-inch stroke will fire and secure nails greater than two inch and up to 3.25 inch.

### BACKGROUND OF THE INVENTION

The skilled carpenter and craftsman are constantly seeking devices to perfect their craft. However, it often happens that certain existing devices are not completely suitable for specific tasks. One such area is the use of nail guns.

The housing market is moving towards high efficiency which means that in the coming years residential buildings will have styrofoam exteriors attached to the wood frames (some builders are already doing this). The thicker the styrofoam, the more energy efficient the home. This is a way to fasten the foam with the same speed as conventional plywood or a thinner foam.

The current invention was developed with a need for such a product, as the inventors were advised that this doesn't exist, and that it isn't possible because a 3″ piston stroke would damage the foam.

### SUMMARY OF THE INVENTION

The present invention has achieved the alleged “impossible” goal by converting a nailer with a 2″ stroke to fire a 3.25″ nail.

By utilizing a shorter stroke to fasten a longer nail, this will not damage the foam. The original gun has an automatic cap feeder which still functions with a 3.25″ nail.

In one embodiment, the present invention is a modification to a 2.5″ cap nail gun, which is configured such that the gun now will feed 3.25″ nails which can be used to fasten 2″ thick styrofoam. Until now the only way to fasten styrofoam this thick is by hand nails or hand screwing. This will speed up the building process for trades in the construction industry that deal with high efficiency buildings.

Among other things, the present invention:

shoots 3.25″ fastener with an auto fed plastic cap will not damage Styrofoam sheeting because the piston stroke is 2″

is configured to fasten 2″ and 1″ styrofoam with a 3.25″ cap nail.

In one embodiment, the present invention is a nail gun system used with an existing two-inch stroke nail cap gun, said system comprising:

a modified nail drum feeder configured to hold and feed nails greater than two inches and up to 3.25 inches;

a modified nail escapement affixed to an existing two inch stroke nail cap gun configured to hold and launch nails greater than two inches and up to 3.25 inches, whereby said modified nail escapement is configured to secure nails greater than two inches and up to 3.25 inches with said nail cap gun having a two inch stroke.

In one embodiment, the nail gun system has a nail drum feeder configured to hold and feed 2.5-inch cap nails.

In one embodiment, the nail gun system has a nail drum feeder that is configured to hold and feed 3.25-inch cap nails.

In one embodiment, the nail gun system has a modified nail escapement affixed to an existing two-inch stroke nail cap gun configured to hold and launch 2.5-inch nails.

In one embodiment, the nail gun system has a modified nail escapement affixed to an existing two-inch stroke nail cap gun configured to hold and launch 3.25-inch nails.

In one embodiment, the nail gun system is a system affixes a nail greater than two inches using a two-inch stroke to styrofoam mounted on a mounting surface to an acceptable depth.

In one embodiment, the nail gun system affixes a 2.5-inch nail using a two-inch stroke to styrofoam mounted on a mounting surface to an acceptable depth.

In one embodiment, the nail gun system affixes a 3.25-inch nail using a two-inch stroke to styrofoam mounted on a mounting surface to an acceptable depth.

### BREIF DESCRIPTION OF THE SEVERAL VIEWS OF THE DRAWINGS

FIG. 1 is side view of one embodiment of the present invention.

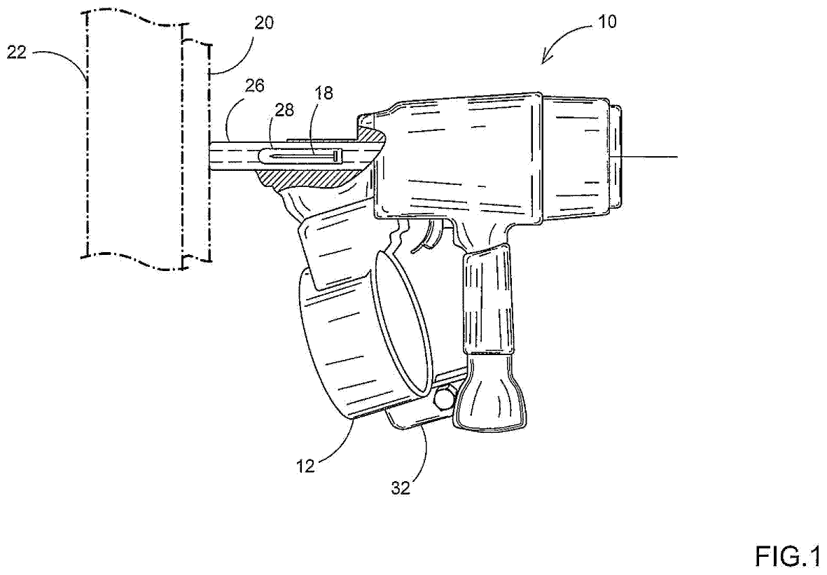

FIG. 2 is side view of one embodiment of the present invention showing firing of a nail.

FIG. 3 is side view of one embodiment of the present invention showing firing of a nail to an unacceptable depth.

FIG. 4 is side view of one embodiment of the present invention showing the elongated forming item to accept 3.25-inch nails.

FIG. 5 is side view of one embodiment of the present invention showing securing 2-inch styrofoam to a frame.

FIG. 6 is side view of one embodiment of the present invention showing securing one-inch styrofoam to a frame.

### DETAILED DESCRIPTION OF THE PREFERRED EMBODIMENT

The present invention is a novel system whereby an existing nail gun with a two-inch stroke is modified to secure nails longer than two inches. In a preferred embodiment, the system will shoot nails 3.25 inches. However, in one embodiment, the modification is contemplated as being configured to shoot nails greater than two inches and up to 3.25 inches using a two-inch stroke.

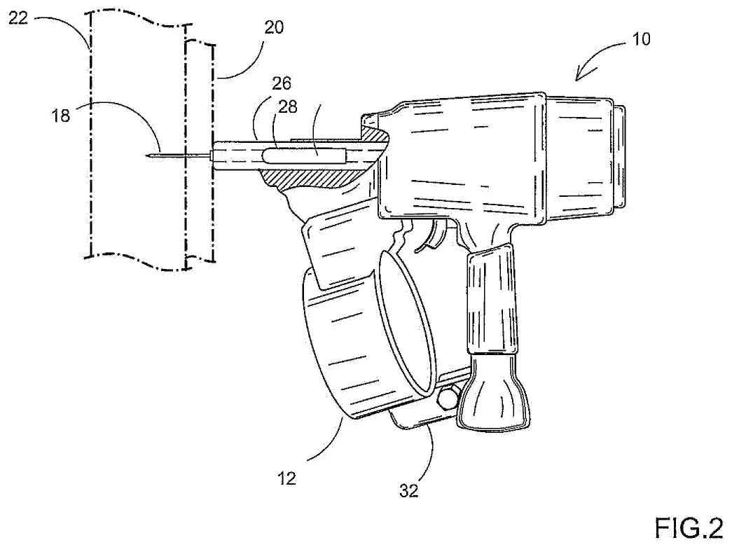

System 10, in one embodiment, has a 2.5-inch nail drum feeder 12. A 2.5-inch cap nail 18 is positioned in a 2.5-inch nail loading escapement 28 configured to launch nail 18 through nail gun barrel 26 and into one-inch thick styrofoam 20 that is on mounting surface 22. As seen in FIG. 2, the 2.5-inch nail is launched with a two-inch stroke and sets the one-inch styrofoam 20 onto mounting surface 22.

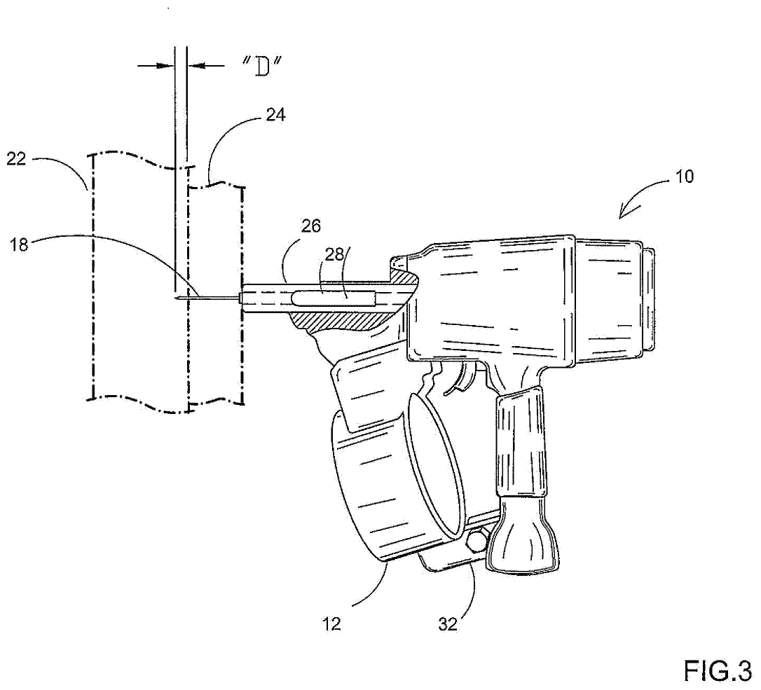

As seen In FIG. 3, dimension D represents an unacceptable depth for 2.5-inch cap nail 18 being driven into two-inch styrofoam 24 on mounting surface 22. The penetrating end of 2.5-inch cap nail 18 must extend past dimension length D in order to provide the desired strength in securing styrofoam 24 to surface 22.

It is contemplated in the present invention that dimension D is half the thickness of the material being applied or ¾″, whichever is greater. In the particular embodiment of FIG. 3 in which two-inch styrofoam 24 is utilized, dimension D is 1.25″.

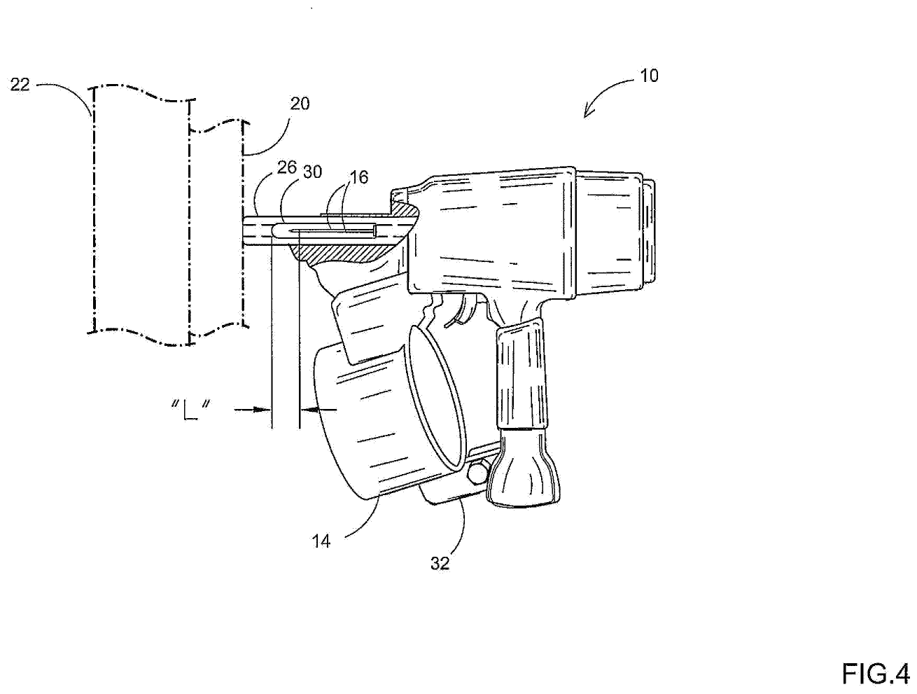

FIG. 4 demonstrates a dimension L representing the Length of elongated escapement 30 configured to hold and use 3.25-inch cap nail 16. Nails are positioned into 3.25-inch cap nail drum feeder 14 that is held in position by cap nail drum feeder 32.

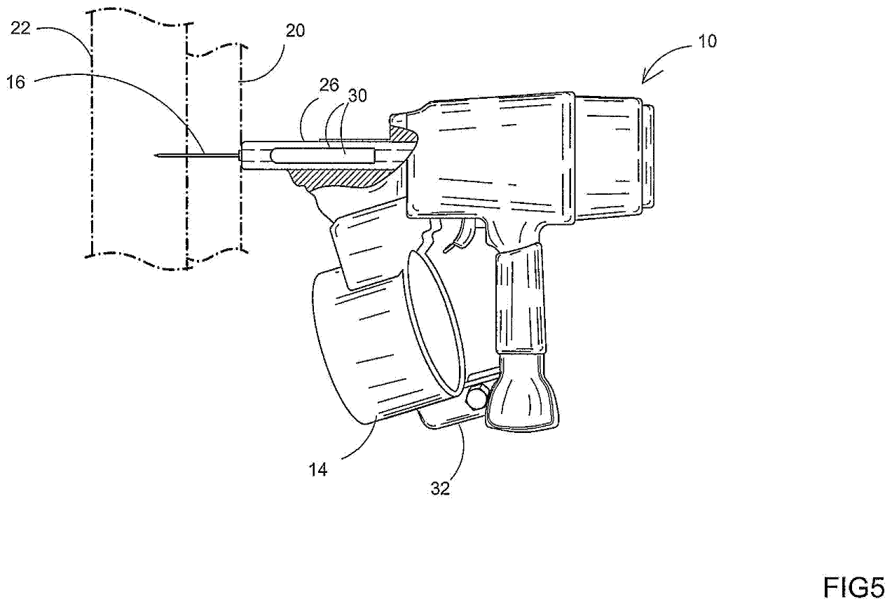

FIG. 5 demonstrates the two-inch stroke driving a 3.25 nail into two-inch styrofoam 26 on mounting surface 22. As generally understood, the stroke or movement of the piston pin is 2¼ inches. For 3¼ inch nail, this reduction is enough to secure the nail into position successfully without damaging the phone sheathing being attached. As described herein, the present invention has achieved the desired result of fastening nail successfully when the stroke or movement of the piston pin is smaller than the length of the nail.

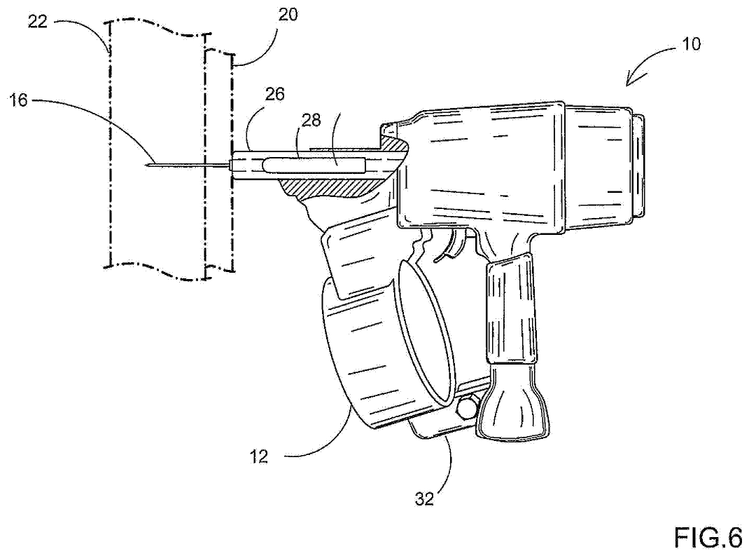

FIG. 6 demonstrates the two-inch stroke driving a 3.25 nail into one-inch styrofoam 20 on mounting surface 22.

As generally understood, an existing nail cap gun is modified in a manner in which experts conjectured would not work.

The existing drum feeder is replaced with a drum feeder to accommodate either 2.5 inch or 3.25-inch cap nails. Additionally barrel 26 is modified to accommodate the longer nails. The system of the present invention achieves the desired result of firing cap nails larger than two inches utilizing a nail gun that produces a two-inch stroke.

The present invention fulfills a great need as two-inch stroke nail cap guns are common, and a user needs to merely utilize the modifications described herein to achieve the desired purpose.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed:

1. A nail gun system used with an existing two-inch stroke nail cap gun, said system comprising:
a modified nail drum feeder configured to hold and feed nails greater than two inches and up to 3.25 inches;
a modified nail escapement affixed to an existing two inch stroke nail cap gun configured to hold and launch nails greater than two inches and up to 3.25 inches, whereby said modified nail escapement is configured to secure nails greater than two inches and up to 3.25 inches with said nail cap gun having a two inch stroke.

2. The nail gun system of claim 1, wherein said nail drum feeder is configured to hold and feed 2.5-inch cap nails.

3. The nail gun system of claim 1, wherein said nail drum feeder is configured to hold and feed 3.25-inch cap nails.

4. The nail gun system of claim 1 wherein said modified nail escapement affixed to an existing two-inch stroke nail cap gun configured to hold and launch 2.5-inch nails.

5. The nail gun system of claim 1 wherein said modified nail escapement affixed to an existing two-inch stroke nail cap gun configured to hold and launch 3.25-inch nails.

6. The nail gun system of claim 1 wherein said system affixes a nail greater than two inches using a two-inch stroke to styrofoam mounted on a mounting surface to an acceptable depth.

7. The nail gun system of claim 1 wherein said system affixes a 2.5-inch nail using a two-inch stroke to styrofoam mounted on a mounting surface to an acceptable depth.

8. The nail gun system of claim 1 wherein said system affixes a 3.25-inch nail using a two-inch stroke to styrofoam mounted on a mounting surface to an acceptable depth.
